(19) United States
(12) Patent Application Publication
(10) Pub. No.: US 2025/0238244 A1
(43) Pub. Date: Jul. 24, 2025

(54) TUNING OPERATION PARAMETERS OF AN APPLICATION

(71) Applicant: Google LLC, Mountain View, CA (US)

(72) Inventor: Kentaro Hara, Tokyo (JP)

(21) Appl. No.: 19/033,403

(22) Filed: Jan. 21, 2025

Related U.S. Application Data
(60) Provisional application No. 63/622,406, filed on Jan. 18, 2024.

(51) Int. Cl. G06F 9/445; G06F 11/34

(52) U.S. Cl. CPC G06F 9/44505; G06F 11/3409

(57) ABSTRACT

Disclosed implementations determine values for a set of operation parameters that improve performance of an application. In an example implementation, a device configuration associated with a device and an application is received. A configuration group is determined based on the device configuration. A set of values for operation parameters associated with the application is determined based on the configuration group. The set of values are used for the operation parameters.

### CROSS-REFERENCE TO RELATED APPLICATION

This application claims priority to U.S. Provisional Patent Application No. 63/622,406, filed on Jan. 18, 2024, entitled “TUNING OPERATION PARAMETERS OF AN APPLICATION”, the disclosure of which is incorporated by reference herein in its entirety.

### BACKGROUND

Operation parameters are data configurations that determine how an application or algorithm performs. Tuning operation parameters includes selecting a set of values for a specific application or device configuration. Because the value of the parameters can affect the performance of a particular user device, the values selected for the operation parameters can have a significant impact on the performance of the application.

### SUMMARY

Implementations of the present disclosure are generally directed to performance tuning systems that train machine learning models to determine values for a set of operation parameters that improve performance of an application (e.g., a client application such as a browser) associated with the operation parameters. These systems may train a machine learning model with performance data reflecting execution of an application on various combinations of device configurations and variable settings. A cost function may be used to evaluate the performance data and determine the set of values for the operation parameters that represent best performance for the application given a particular device configuration.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

The following detailed description that sets forth aspects of the subject matter, along with the accompanying drawings of which:

FIG. 1A is an example machine learning model that can be employed by implementations of the present disclosure;

FIG. 1B is an example cost function that can be employed by implementations of the present disclosure;

FIG. 2 is an example of a dense neural network that can be employed by implementations of the present disclosure;

FIG. 3 is an example environment that can be employed to execute implementations of the present disclosure;

FIG. 4 is a flowchart of a non-limiting process that can be performed by implementations of the present disclosure; and

FIG. 5 is an example system that includes a computer or computing device that can be programmed or otherwise configured to implement systems or methods of the present disclosure.

### DETAILED DESCRIPTION

An application may include a set of operation parameters (e.g., hyperparameters) to improve performance and memory. Example operation parameters can include the number of network requests that can be sent to the underlying network stack concurrently, the thresholds to trigger garbage collection, the cache capacity of a module's memory cache, and the like. A non-limiting example of an application that includes a set of operation parameters is a browser application. Because there is an interplay between operational parameters and the user device configuration (e.g., operating system type, available amounts and types of memory, and the like) the values selected for the operation parameters can lead to poor performance.

A technical problem exists in determining values for different configurations that maximize performance of the user device. Current solutions include tuning these operation parameters to “optimal” values via real-world experiments. The values may be hard coded in a codebase for the application. One problem of this approach is the high cost (bandwidth, processing cycles, memory, time, and so forth) of running a single experiment with real-world data, making it difficult to collect sufficient data. For example, a statistically significant result may require multiple-day aggregation of data from a small percentage of stable users. Moreover, each experiment tests a relatively small number of values, further increasing the burden to collect sufficient data.

Another currently used solution for tuning operation parameters is to evaluate the performance of the operation parameters using lab benchmarks. However, real-world environments are significantly different than lab benchmarks, and therefore the set of operation parameter values determined from lab benchmarks can have limited applicability to real-world environments. Also, accurately testing the high number of possible iterations of both hardware and software configurations for a given application, as well as the connections among the operation parameters regarding performance, using real-world simulations or lab benchmarks is difficult as “optimal” values may change depending on dynamic conditions such as network round-trip time (RTT) and bandwidth. Additionally, the trend of the device types and network conditions evolves, and thus the values that provide the best performance for a set of operation parameters changes constantly.

Accordingly, implementations described herein provide a technical solution to these technical problems. In particular, implementations of the described performance tuning system train a machine learning model to provide values that improve (or maximize) performance for a set of operation parameters associated with an application based on an assigned configuration group. A configuration group represents a combination of user device components and an application. In some implementations, an application instance can thus be assigned to a configuration group based on the configuration of components of the user device. For each configuration group, different values of the operation parameters may be used to collect performance data for the application/device configuration.

In some implementations, the machine learning model is trained with this performance data provided by application/device configuration to simulate real-world performance data for the application. In other words, the trained model can predict performance metrics for an application/device configuration with the operation parameters set to a given set of values, which solves the technical problem of collecting sufficient data in a real-word environment. Generally, performance metrics are the indicators used to measure and track the performance of an application. In some examples, the system analyzes the performance metrics and bases the values of the operation parameters selected for the configuration group according to a cost function. In some examples, the described system provides a set of values for the operation parameters of an application that are identified via the trained machine learning model based on the device configuration of a user device executing the application.

Machine-learning algorithms include algorithms that are trained through a process that adjusts the parameters and weights of the algorithm to increase its performance. Examples of machine learning algorithms include deep neural networks, convolutional neural networks (CNNs), recurrent neural networks, long-short term memory (LTSM) networks, and transformer (e.g., vision transformer (ViT)) networks, a support vector machine (SVM), a naïve Bayes classification, a random forest, a neural network, deep learning, or other supervised learning algorithm or unsupervised learning algorithm for classification and regression. Training a neural network typically requires curation of real-world data where the expected outputs of the neural network are already determined. The machine learning algorithms may be trained using one or more training datasets.

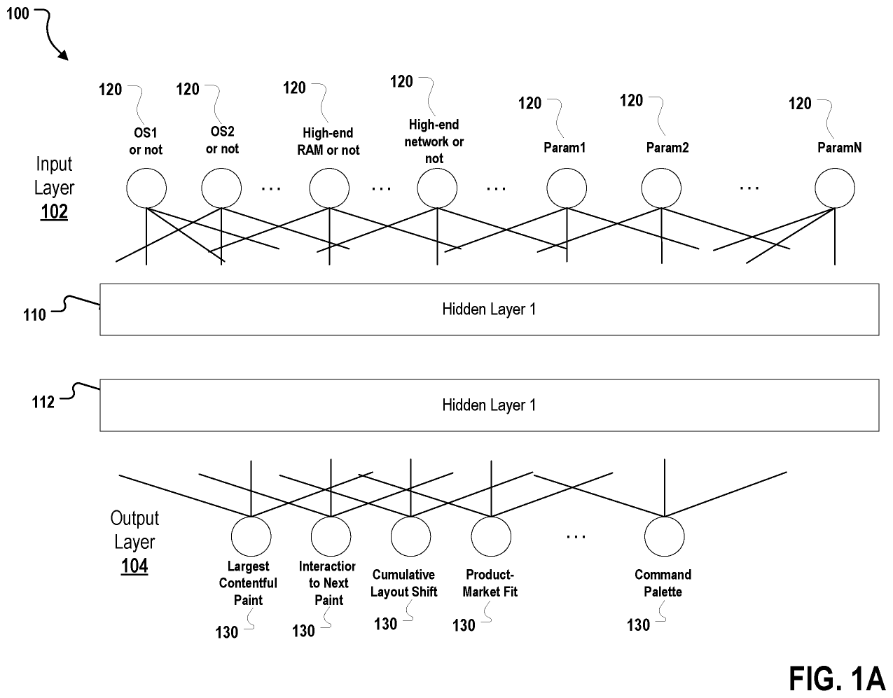

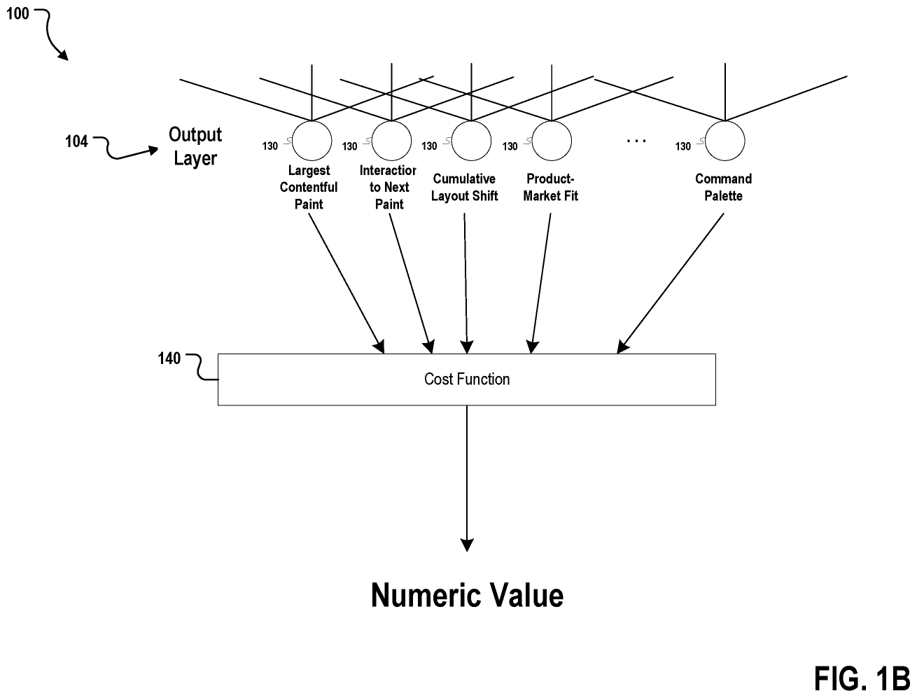

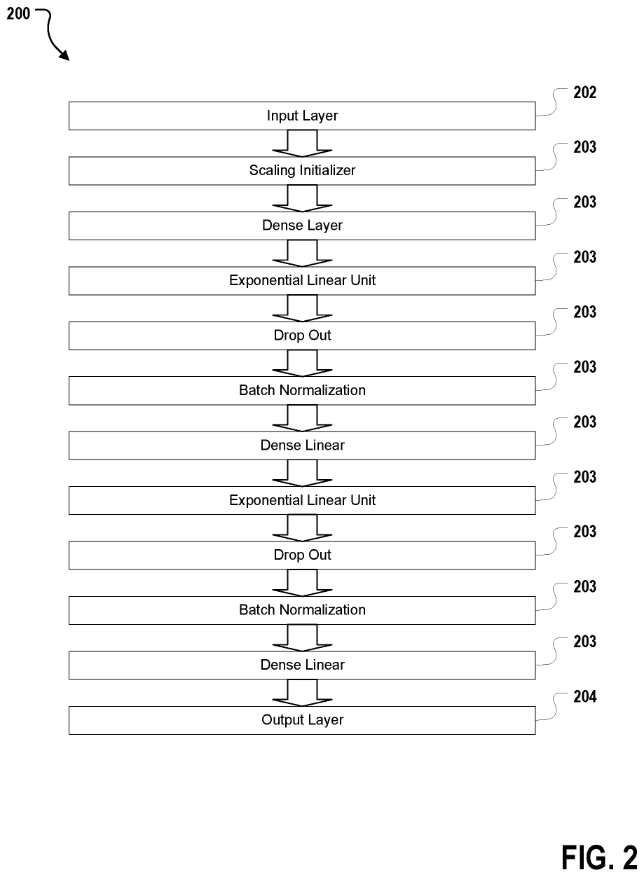

In disclosed implementations, the training datasets may include performance data collected for a configuration group. The training datasets can be obtained by, for example, an application deployed to a device configured to provide training data. For example, an application may receive testing values for operation parameters employed by the application and provide performance data (e.g., performance metrics) as a result of execution of the application using the operation parameter testing values. The testing values and respective performance data may be employed to train a machine learning model to simulate the behavior of the application when deployed to various devices and with various device configurations (see the descriptions of FIGS. 1A, 1B, and 2 below for more detail).

In some implementations, the performance data includes an identifier for the configuration group, the values of the operation parameter (including an identifier representing the values used), and the measured performance metrics; thus, the performance metrics may lack personally identifiable information. Further to the descriptions above, a user may be provided with controls allowing the user to make an election as to both if and when systems, programs, or features described herein may enable collection of user information (e.g., information about the performance metrics collected for a device configuration), and if the user is sent content or communications from a server. In addition, certain data may be treated in one or more ways before it is stored or used, so that personally identifiable information is removed. For example, a user's identity may not be used or may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The performance data collected for the configuration group may be employed to train various algorithms. Moreover, as described above, these algorithms can be continuously trained/retrained using real-time user data as it is received. Thus, in some implementations, new values can be determined for new device configurations or using new performance metrics by collecting new training data. In some implementations, the machine learning algorithm employs regression modeling where relationships between variables are determined and weighted. In some implementations, the machine learning algorithms employ regression modeling where relationships between predictor variables and dependent variables are determined and weighted.

FIG. 1A is an example neural network 100 that can be trained as a machine learning model and employed to simulate real-world performance of an application (e.g., a browser) and provide operation parameters to improve performance and memory of the application. The neural network 100 includes multiple hidden layers (often referred to as a “deep learning” network) where each layer extracts increasingly complex features from the data. It is contemplated, however, that implementations of the present disclosure can be realized with any of the appropriate machine learning algorithms, such as those mentioned previously, and layers.

As depicted, the neural network 100 includes two hidden layers 110 and 112. However, the number of hidden layers needed depends on the complexity of the problem. Simple tasks may only require one hidden layer, while more intricate tasks might necessitate several hidden layers. Accordingly, implementation include a machine learning model trained using a neural network having any number of hidden layers based on, for example, the number of neurons within each layer, the function performed by each layer, the types of data used to train the machine learning model, the type of application and/or device configuration for the model is trained, and so forth.

A “hidden layer” in a neural network refers to a layer of neurons situated between the input layer 102 and the output layer 104, where the data is processed and transformed internally. The hidden layers 110 and 112 allow the network to learn complex patterns and relationships within the data without directly observing the computations happening within that layer; essentially, a hidden layer provides a “middle ground” that enables a neural network to perform more intricate tasks than a simple input-output relationship.

In some implementations, hidden layers receive the output from a previous layer, either the input layer or another hidden layer (see FIG. 2), and process the output further using activation functions that allow the network to extract meaningful features from the data. By applying activation functions, hidden layers introduce non-linearity into the network, which is useful for learning complex patterns that cannot be captured with linear models.

In a neural network, a “neuron” refers to a computational unit that receives input signals, performs a weighted sum calculation, applies an activation function to that sum, and then outputs a result, essentially mimicking the function of a biological neuron in the brain by processing information and passing it on to other neurons within the network. Essentially, a neuron is the basic building block of an artificial neural network, acting as a node within the network that can learn and adapt based on the data it receives.

In some implementations, a device configuration is representative of an environment in which the application is executing on the device. A device configuration includes a set of settings or parameters that are specific to a particular device. In some cases, the device configuration is employed to customize how a specific application or a specific type of application behaves on a specific device or type of device. The device configuration allows for tailored functionality based on, for example, the device's hardware, operating system, screen size, and the like. Using a device configuration having parameter values that are tuned to a specific device optimizes (i.e., maximizes) the respective application's performance and improves user experience across various devices and device types.

In some implementations, a device configuration includes, for example, the hardware and software configurations for a device type (e.g., operating systems, the RAM size, the network speed) used to execute the application. In some cases, device configurations are categorized into configuration groups. Each configuration group thus represents a different execution environment for the application. In some implementations, the machine learning model trained using the neural network 100 is employed to determine values and predict performance metrics for a combination of N operation parameters for a configuration group without running extensive and expensive real-world experiments or lab benchmarks.

As depicted in FIG. 1A, the operation parameters 120 are provided as input to the neural network 100 (i.e., input parameters to the machine learning model). As described above, the operation parameters 120 represent attributes of a user device that may be included in a device configuration. Example operation parameters 120 include, but are not limited to, operating system type, read only memory (RAM) capability, network type and/or capability, network settings, screen resolution, screen density, device orientation (e.g., portrait or landscape), processor type, memory availability, operating system version, application settings (e.g., font size, layout, color schemes, feature availability).

In some implementations, the operation parameters 120 are encoded into an input vector(s) (e.g., a one-hot vector). A one-hot vector is a binary vector that represents a categorical variable by setting one element to 1 and all others to 0. One-hot vectors are used in machine learning to convert categorical data (e.g., the operation parameters 120) into a numerical format. In some implementations, the input vector has a dimension equal to the quantity of (number of) defined configuration groups plus N, where N is the quantity of operation parameters 120. For example, the operation parameters 120 may include five possible operating system types (“OS Types”) on which an application is programed to execute, three possible RAM type (“RAM type) for which the application is programed to employ, and three type of networks for which the application is programmed to interface. In such an example, the OS type, the RAM type and the Network type are encoded into one-hot vectors where the input vector has a dimension of 5+3+3+N or 11+N, where N represents the number of (quantity of) other input parameters. Thus, for such an example, the input layer 102 has 11+N neurons. In some implementations, the operation parameters include slices of the population by platform/OS type, RAM type (e.g., high-end, middle tier, low-end, and network type (e.g., high-end network, middle tier network, low-end network) and not by sites.

As depicted in FIG. 1A, implementations described herein train the neural network 100 (i.e., the trained machine learning model) to predict values for these performance metrics 130 given the input parameters (i.e., the operation parameters 120). In some implementations, the output layer 104 provides performance metrics 130 based on the provided input parameters (i.e., the operation parameters 120). In some cases, performance metrics include a set of metrics that measure how well an application loads, interacts with users, looks, and so forth when executing on the particular device (i.e., based on the device configuration). In some implementations, performance metrics 130 provided by the output layer 104 are provided as an output vector. In some cases, the output vector has a dimension of M where M represents the quantity of (number of) performance metrics 130 measured at a user device using the device configuration represented by the input parameters. Thus, in such cases, the output layer has M neurons. Example performance metrics 130 can include, but are not limited to, largest contently paint (LCP), cumulative layout shift (CLS), interaction to next paint (INP), product-market fit (PMF), command palette (CCP), or any other performance statistic obtained through execution of the application. Operation parameters may be any parameter that a software developer can set and are often not visible to/set by users.

FIG. 1B shows a cost function 140 used to map the performance metrics 130 provided by the output layer 104 to a cost function 140. As an example, machine learning model trained using the neural network 100 may provide various combinations of output performance metric values (e.g., LCP=+0.5%, INP=−2.0%, PMF=+0.2%, . . . or LCP=−1.2%, INP=+1.0%, PMF=+0.4%, . . . ). In some implementations, the cost function 140 is used to generate an evaluation metric that is used to compare the various combinations to determine the set of operation parameters. The evaluation metric can be any value that can be used to compare (evaluate, rank) one set of performance metrics to another.

In some cases, the cost function 140 is a mathematical formula that measures how well the machine learning model (i.e., the trained neural network) predicts the performance metrics 130. In some cases, the cost function 140 may be referred to as a loss function. In some cases, the cost function 140 calculates a difference between the machine learning model's predicted values (i.e., the performance metrics 130) and the actual values (e.g., measured values from collected data that is used during training). In some implementations, the cost function 140 outputs a single number that represents the average error where the goal of minimizing the cost function is to find the values producing the smallest error. In some cases, the cost function 140 is employed to improve the model's accuracy. In some cases, the cost function 140 can be used in linear regression or logistic regression. In some cases, the cost function 140 can be optimized using gradient descent (i.e., an algorithm that finds the minimum error).

As an example, for each configuration group, a set of random values are assigned to the N operation parameters in the input layer 102. The cost is then calculated using the machine learning model trained using the neural network 100 and the input values are adjusted using back propagation until the cost function is minimized (and therefore the values for the set of operation parameters are determined for each configuration group). In some implementations, the weights of the machine learning model trained using the neural network 100 are fixed. The determined combinations of the N operation parameters are provided to the respective application. In some implementations, the machine learning model is trained using the neural network 100 and reinforcement learning.

In some implementations, an additional parameter is added to the machine learning model trained using the neural network 100 via an additional neuron to the input layer 102 while preserving the weights in the neural network. A dataset that includes the additional parameter is provided and the machine learning model is retrained accordingly trained using the neural network 100.

FIG. 2 depicts a dense neural network 200 that may be used to train a machine learning model with performance data provided by a device configuration to simulate real-world performance data for the application. As described above, the trained model can predict performance metrics for an application or device configuration with the operation parameters set to a given set of values, which solves the technical problem of collecting sufficient data in a real-word environment. In some cases, the machine learning model is trained to predict the top-level metrics for a given combination of the N hyperparameters for a given user group.

The dense neural network 200, also referred to as a fully connected neural network, is a type of artificial neural network where every neuron in a layer (e.g., input layer 202, middle or hidden layers 203, and output layer 204) is connected to every neuron in the following layer, meaning there is complete connectivity between layers 202, 203, and 204, and thus allowing the dense neural network 200 to learn complex relationships within data by processing information through these interconnected nodes. Due to the high level of connectivity, the dense neural network 200 can effectively learn intricate patterns and relationships within data, such as the relationship between a device configuration and operational parameters related to a device on which the application is programmed to execute.

As depicted in FIG. 2, the hidden or middle layers may include various types of layers. For example, a scaling initializer layer is a special layer that sets the initial weights of a subsequent layer by scaling them according to a specific calculation, usually based on the number of input connections (fan-in) to that layer. A scaling initializer layer is employed to prevent issues such as vanishing or exploding gradients during training by keeping the variance of activations consistent across layers. In some implementations, a scaling initializer layer controls the scale of the initial weights to ensure proper signal propagation through the network.

Another example layer that may be used in the dense neural network 200 is a dense layer. A defense layer is a layer where every neuron receives input from all neurons in the previous layer, meaning each neuron is fully connected to the preceding layer, hence the term “dense”. A dense layer may be used for final classifications or to project data into a new feature space after other layers like convolutional layers extract features.

Another example layer that may be used in the dense neural network 200 is an Exponential Linear Unit (ELU) layer, which is a type of activation function used in neural networks that outputs the input value directly for positive values. The ELU layer may apply an exponential function to produce a small negative value for negative inputs. Essentially an ELU layer acts like a smoothed-out version of an Rectified Linear Unit (ReLU) layer (e.g., a layer setting any negative values to zero while keeping positive values unchanged) with the ability to output negative values. An ELU layer can improve training dynamics and convergence speed in deep learning models. In some cases, an ELU layer is defined by a parameter “alpha” that controls the shape of the negative exponential curve.

Another example layer that may be used in the dense neural network 200 is a dropout layer, which employs a regularization technique that randomly “drops out” (e.g., sets to zero) a certain percentage of neurons during training. In some cases, a drop out layer prevents the network from overfitting by forcing each neuron to learn more robust features independently, rather than relying too heavily on specific connections between neurons.

Another example layer that may be used in the dense neural network 200 is a batch normalization layer. In some cases, a batch normalization layer employs a technique that normalizes the inputs of a layer by re-centering and re-scaling them based on the statistics (e.g., mean, standard deviation, and the like) calculated within a mini batch of data. A batch normalization layer stabilizes the training process and improves the network's ability to learn by mitigating “internal covariate shift” where the input distribution changes significantly across layers during training. A batch normalization layer typically involves calculating the mean and variance of a batch and normalizing each element by subtracting the mean and dividing by the standard deviation, with additional learned scaling and shifting parameters to further adjust the normalized values.

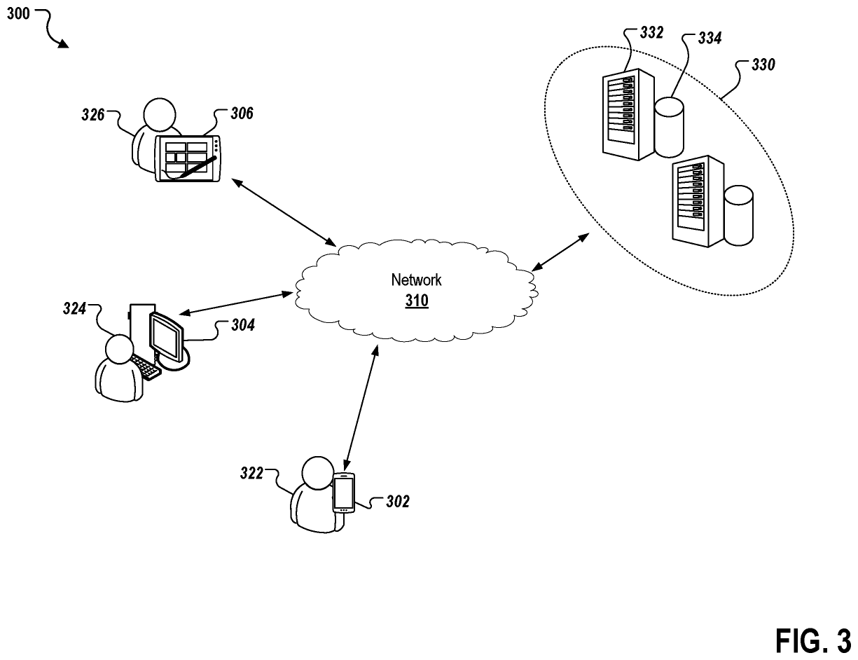

FIG. 3 depicts an example environment 300 that can be employed to execute implementations of the present disclosure. The example environment 300 includes computing devices 302, 304, 306; a back-end system 330, and a communication network 310. The communication network 310 may include wireless and wired portions. In some cases, the communication network 310 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a public switched telephone network. The communication network 310 may also include future developed networks. In some implementations, the communication network 310 includes the Internet, an intranet, an extranet, or an intranet and/or extranet that is in communication with the Internet. In some implementations, the communication network 310 includes a telecommunication or a data network.

In some implementations, the communication network 310 connects web sites, devices (e.g., the computing devices 302, 304, and 306) and back-end systems (e.g., the back-end system 330). In some implementations, the communication network 310 can be accessed over a wired or a wireless communications link. For example, mobile computing devices (e.g., the smartphone device 302 and the tablet device 306), can use a cellular network to access the communication network 310.

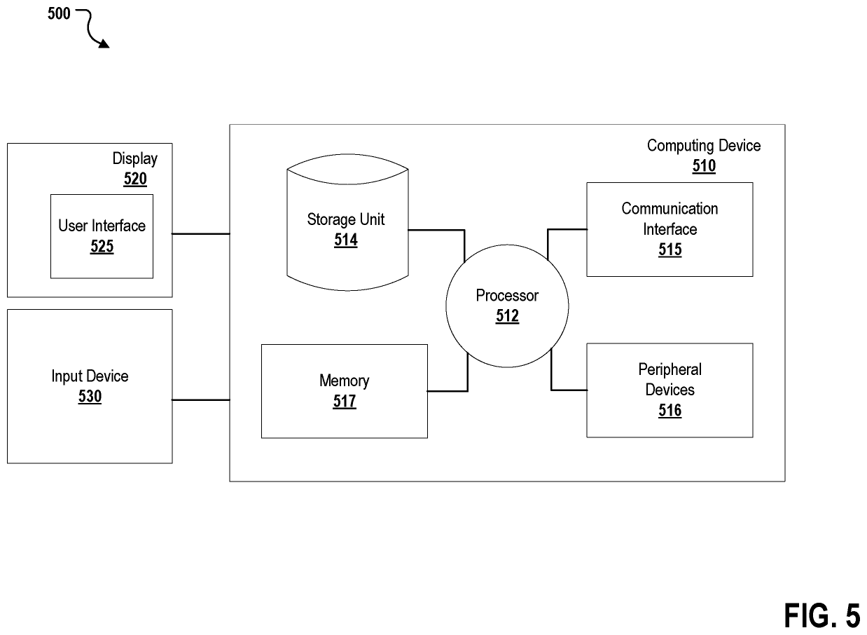

In some examples, the users 322, 324, and 326 interact with the system through a graphical user interface (GUI) (e.g., the user interface 525 described below with reference to FIG. 5) or client application (e.g., a browser application) that is installed and executed on their respective computing devices 302, 304, or 306. In some examples, the computing devices 302, 304, and 306 provide viewing data to screens with which the users 322, 324, and 326, can interact. In some implementations, the computing devices 302, 304, 306 are sustainably similar to computing device 510 described below with reference to FIG. 5. The computing devices 302, 304, and 306 may each include any appropriate type of computing device, such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

Three user computing devices 302, 304, and 306 are depicted in FIG. 3 for simplicity. In the depicted example environment 300, the computing device 302 is depicted as a smartphone, the computing device 304 is depicted as a tablet-computing device, and the computing device 306 is depicted as a desktop computing device. It is contemplated, however, that implementations of the present disclosure can be realized with any of the appropriate computing devices, such as those mentioned previously. Moreover, implementations of the present disclosure can employ any number of devices as required.

In some implementations, the back-end system 330 includes at least one server device 332 and optionally, at least one data store 334. In some implementations, the server device 332 is sustainably similar to computing device 510 described below with reference to FIG. 5. In some implementations, the server device 332 is a server-class hardware type device. In some implementations, the back-end system 330 includes computer systems using clustered computers and components to function as a single pool of seamless resources when accessed through the communication network 310. For example, such implementations may be used in data center, cloud computing, storage area network (SAN), and network attached storage (NAS) applications. In some implementations, the back-end system 330 is deployed using a virtual machine(s).

In some implementations, the data store 334 is a repository for persistently storing and managing collections of data. Example data stores that may be employed within the described system include data repositories, such as a database as well as simpler store types, such as files, emails, and so forth. In some implementations, the data store 334 includes a database. In some implementations, a database is a series of bytes or an organized collection of data that is managed by a database management system (DBMS).

In some implementations, the back-end system 330 hosts one or more computer-implemented services provided by the described system with which users 322, 324, and 326 can interact using the respective computing devices 302, 304, and 306. For example, in some implementations, the back-end system 330 is configured to provide values for a set of operation parameters associated with a client application executed by the user computing devices 302, 304, or 306. In some examples, the techniques discussed herein may be incorporated into a browser application or platform (e.g., provided via the back-end system 330 to the user devices 302, 304, and 306) in which information may be determined (e.g., the values for a set of operation parameters) without cross-site tracking or without the use of third-party cookies.

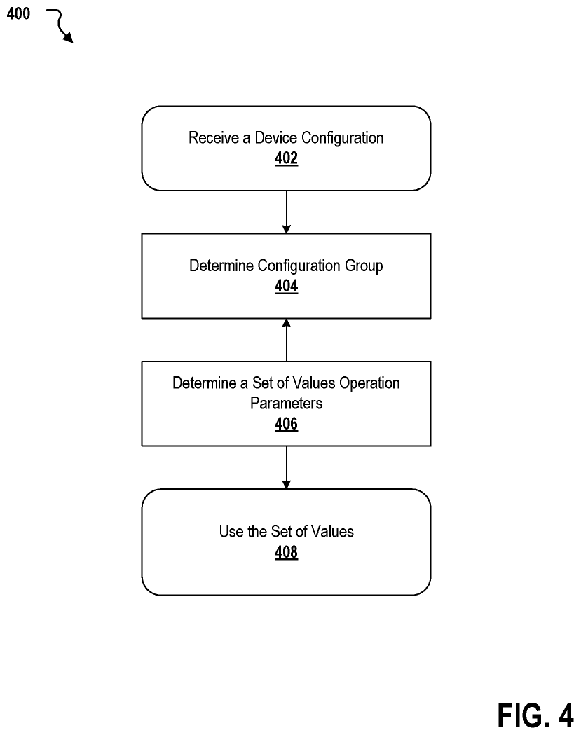

FIG. 4 depicts a flowchart of an example process 400 that can be provided by implementations of the present disclosure. The example process 400 can be implemented by systems and components described with reference to FIGS. 1A, 1B, 2, 3, and 5. The example process 400 generally shows in more detail how operation parameters are tuned for given static conditions (e.g., operating system, RAM size, CPU cores, and the like) and dynamic conditions (e.g., network RTT, bandwidth, and the like) using a trained machine learning model. In some implementations, the set of operation parameters tuned according to the trained model as well as the default, highest, and lowest values are defined in a configuration file.

For clarity of presentation, the description that follows generally describes the example process 400 in the context of FIGS. 1A, 1B, 2, 3, and 5. However, it will be understood that the process 400 may be performed, for example, by any other suitable system, environment, software, and hardware, or a combination of systems, environments, software, and hardware as appropriate. In some implementations, various operations of the process 400 can be run in parallel, in combination, in loops, or in any order.

At 402, a device configuration associated with a device and an application is received. In some implementations, the device configuration includes a configuration of hardware and a configuration of software executed by the hardware. In some implementations, the device configuration includes a plurality of input parameters. In some implementations, the plurality of input parameters is encoded into one-hot vectors. In some implementations, the application is a client application. In some implementations, the application comprises a browser application.

From 402, the process 400 proceeds to 404 where a configuration group is determined based on the device configuration. From 404, the process 400 proceeds to 406 where a set of values for operation parameters associated with the application are determined based on the configuration group. In some implementations, an evaluation metric for the performance metric values is determined. In some implementations, the cost function is adjusted using back propagation. In some implementations, the model is trained using reinforcement learning. In some implementations, the model is trained with training data received from a plurality of devices executing the client application.

In some implementations, a set of test parameters is provided to the plurality of devices; and the training data is received from the plurality of devices based on the set of test parameters. In some implementations, a value for an operation parameter is determined based on the evaluation metric. In some implementations, the plurality of operation parameters is set based on the set of values. In some implementations, the set of values for the plurality of operation parameters is provided to the device or the application. In some implementations, the device or the application is configured to set the plurality of operation parameters according to the set of values. In some implementations, the performance of the application is increased based on the plurality of operation parameters.

From 406, the process 400 proceeds to 408 where the set of values for the operation parameters are used by the device. In some implementations, the set of values for the operation parameters are tuned using a cost function and a model. In some implementations, the set of values is further tuned by assigning random values to the set of values and providing the set of values to an input layer of the model as input variables. In some implementations, providing the input variables to the input layer includes encoding the input variables into an input vector, wherein a dimension of the input vector is defined based on a quantity of configuration groups and a quantity of operation parameters.

In some implementations, the set of values is further tuned by receiving, as output from the model, a set of performance metrics associated with execution of the application by devices having the device configuration and providing the set of performance metrics to the cost function. In some implementations, the set of values is further tuned by minimizing an output of the cost function by adjusting values assigned to the operation parameters using back propagation and the model.

In some implementations, the device configuration includes a configuration of components of the device associated with an instance of the application. In some implementations, the configuration group is determined based on the configuration of the components and the instance of the application. In some implementations, the application is configured to execute on the device. In some implementations, using the set of values for the operation parameters includes setting the operation parameters on the device to the set of values and executing the application on the device. In some implementations, executing the application on the device using the set of values maximizes a performance of the application on the device. From 408, the process 400 ends or repeats.

FIG. 5 depicts an example computing system 500 that includes a computer or computing device 510 that can be programmed or otherwise configured to implement systems or methods of the present disclosure. For example, the computing device 510 can be programmed or otherwise configured to implement the process 400.

In the depicted embodiment, the computer or computing device 510 includes an electronic processor (also “processor” and “computer processor” herein) 512, such as a central processing unit (CPU) or a graphics processing unit (GPU), which is optionally a single core, a multi core processor, or a plurality of processors for parallel processing. The depicted embodiment also includes memory 517 (e.g., random-access memory, read-only memory, flash memory), electronic storage unit 514 (e.g., hard disk or flash), communication interface module 515 (e.g., a network adapter or modem) for communicating with one or more other systems, and peripheral devices 516, such as cache, other memory, data storage, microphones, speakers, and the like. In some implementations, the memory 517, storage unit 514, communication interface module 515 and peripheral devices 516 are in communication with the electronic processor 512 through a communication bus (shown as solid lines), such as a motherboard. In some implementations, the bus of the computing device 510 includes multiple buses. The above-described hardware components of the computing device 510 can be used to facilitate, for example, an operating system and operations of one or more applications (e.g., a browser application) executed via the operating system. For example, a browser application may be provided via the user interface 525 and configured to manage resource content, such as webpage content, provided by a resource provider (e.g., a web server executed by the back-end system 330 described above with reference to FIG. 3). In some implementations, the computing device 510 includes more or fewer components than those illustrated in FIG. 5 and performs functions other than those described herein.

In some implementations, the memory 517 and storage unit 514 include one or more physical apparatuses used to store data or programs on a temporary or permanent basis. In some implementations, the memory 517 is volatile memory and requires power to maintain stored information. In some implementations, the storage unit 514 is non-volatile memory and retains stored information when the computer is not powered. In further implementations, memory 517 or storage unit 514 is a combination of devices such as those disclosed herein. In some implementations, memory 517 or storage unit 514 is distributed across multiple machines such as a network-based memory or memory in multiple machines performing the operations of the computing device 510.

In some cases, the storage unit 514 is a data storage unit or data store for storing data. In some instances, the storage unit 514 stores files, such as drivers, libraries, and saved programs. In some implementations, the storage unit 514 stores data received by the device (e.g., event data and system settings). In some implementations, the computing device 510 includes one or more additional data storage units that are external, such as located on a remote server that is in communication through a network (e.g., the communication network 310 described above with reference to FIG. 3).

In some implementations, platforms, systems, media, and methods as described herein are implemented by way of machine or computer executable code stored on an electronic storage location (e.g., non-transitory computer readable storage media) of the computing device 510, such as, for example, on the memory 517 or the storage unit 514. In further implementations, a computer readable storage medium is optionally removable from a computer. Non-limiting examples of a computer readable storage medium include compact disc read-only memories (CD-ROMs), digital versatile discs (DVDs), flash memory devices, solid state memory, magnetic disk drives, magnetic tape drives, optical disk drives, cloud computing systems and services, and the like. In some cases, the computer executable code is permanently, substantially permanently, semi-permanently, or non-transitorily encoded on the media.

In some implementations, the electronic processor 512 is configured to execute the code. In some implementations, the machine executable or machine-readable code is provided in the form of software. In some examples, during use, the code is executed by the electronic processor 512. In some cases, the code is retrieved from the storage unit 514 and stored on the memory 517 for ready access by the electronic processor 512. In some situations, the storage unit 514 is precluded, and machine-executable instructions are stored on the memory 517.

Examples of operations performed by the electronic processor 512 can include fetch, decode, execute, and write back. In some cases, the electronic processor 512 is a component of a circuit, such as an integrated circuit. One or more other components of the computing device 510 can be optionally included in the circuit. In some cases, the circuit is an application specific integrated circuit (ASIC) or a field programmable gate arrays (FPGAs). In some cases, the operations of the electronic processor 512 can be distributed across multiple machines (where individual machines can have one or more processors) that can be coupled directly or across a network.

In some cases, the computing device 510 is optionally operatively coupled to a communication network, such as the communication network 310 described above with reference to FIG. 3, via the communication interface module 515, which may include digital signal processing circuitry where necessary. Communication interface module 515 may provide for communications under various modes or protocols, such as global system for mobile (GSM) voice calls, short message/messaging service (SMS), enhanced messaging service (EMS), or multimedia messaging service (MMS) messaging, code-division multiple access (CDMA), time division multiple access (TDMA), wideband code division multiple access (WCDMA), CDMA2000, or general packet radio service (GPRS), among others. Such communication may occur, for example, through a transceiver. In addition, short-range communication may occur, such as using a BLUETOOTH, WI-FI, or other such transceiver. In addition, the computing system 500 may include a Global Positioning System (GPS) receiver module that may provide additional navigation- and location-related wireless data to the computing device 510. In some cases, the computing device 510 communicates with one or more remote computer systems through the communication network. In some cases, a user can access the computing device 510 via the communication network 310. In some cases, the computing device 510 is configured as a node within a peer-to-peer network.

In some cases, the computing device 510 includes or is in communication with one or more output devices 520. In some cases, the output device 520 includes a display to send visual information to a user. In some cases, the output device 520 is a touch sensitive display that combines a display with a touch sensitive element that is operable to sense touch inputs as and functions as both the output device 520 and the input device 530. For example, the output device 520 may include a Thin-Film-Transistor Liquid Crystal Display (TFT LCD) or an Organic Light Emitting Diode (OLED) display, or other appropriate display technology. In still further cases, the output device 520 is a combination of devices such as those disclosed herein. In some cases, the output device 520 displays a user interface 525 generated by the computing device (for example, a browser application executed by the computing device 510).

In some cases, the computing device 510 includes or is in communication with one or more input devices 530 that are configured to receive information from a user. In some cases, the input device 530 is a keyboard. In some cases, the input device 530 is a keypad (e.g., a telephone-based keypad). In some cases, the input device 530 is a cursor-control device including, by way of non-limiting examples, a mouse, trackball, trackpad, joystick, game controller, or stylus. In some cases, as described above, the input device 530 is a touchscreen or a multi-touchscreen. In other cases, the input device 530 is a microphone to capture voice or other sound input. In other cases, the input device 530 is a camera or video camera. In still further cases, the input device is a combination of devices such as those disclosed herein.

In some cases, the computing device 510 includes an operating system configured to perform executable instructions. The operating system is, for example, software, including programs and data that manages the device's hardware and provides services for execution of applications.

It should also be noted that a plurality of hardware and software-based devices, as well as a plurality of different structural components may be used to implement the described examples. In addition, implementations may include hardware, software, and electronic components or modules that, for purposes of discussion, may be illustrated and described as if most of the components were implemented solely in hardware. In some implementations, the electronic-based aspects of the disclosure may be implemented in software (e.g., stored on non-transitory computer-readable medium) executable by one or more processors, such as electronic processor 512. As such, it should be noted that a plurality of hardware and software-based devices, as well as a plurality of different structural components may be employed to implement various implementations. It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, all technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

What is claimed is:

1. A method comprising:
receiving a device configuration associated with a device and an application;
determining a configuration group based on the device configuration;
determining a set of values for operation parameters associated with the application based on the configuration group; and
using the set of values for the operation parameters.

2. The method of claim 1, wherein the set of values for the operation parameters are tuned using a cost function and a model.

3. The method of claim 2, wherein the set of values is further tuned by:
assigning random values to the set of values; and
providing the set of values to an input layer of the model as input variables.

4. The method of claim 3, wherein providing the input variables to the input layer includes:
encoding the input variables into an input vector, wherein a dimension of the input vector is defined based on a quantity of configuration groups and a quantity of operation parameters.

5. The method of claim 4, wherein the set of values is further tuned by:
receiving, as output from the model, a set of performance metrics associated with execution of the application by devices having the device configuration, and
providing the set of performance metrics to the cost function.

6. The method of claim 5, wherein the set of values is further tuned by:
minimizing an output of the cost function by adjusting values assigned to the operation parameters using back propagation and the model.

7. The method of claim 1, wherein the device configuration includes a configuration of components of the device associated with an instance of the application, the method further comprising:
determining the configuration group based on the configuration of the components and the instance of the application.

8. The method of claim 1, wherein the application is configured to execute on the device, and using the set of values for the operation parameters includes:
setting the operation parameters on the device to the set of values, and
executing the application on the device.

9. The method of claim 8, wherein executing the application on the device using the set of values maximizes a performance of the application on the device.

10. A non-transitory computer-readable medium storing executable instructions that when executed an electronic processor, cause the electronic processor to:
receive, from a device, a device configuration associated with the device and an application;
determine a configuration group based on the device configuration;
determine a set of values for operation parameters associated with the application based on the configuration group; and
provide, to the device, the set of values for the operation parameters.

11. The non-transitory computer-readable medium of claim 10, wherein the executable instructions, when executed the electronic processor, further cause the electronic processor to:
tune the set of values for the operation parameters using a cost function and a model.

12. The non-transitory computer-readable medium of claim 11, wherein the set of values is further tuned by:
assigning random values to the set of values; and
providing the set of values to an input layer of the model as input variables.

13. The non-transitory computer-readable medium of claim 12, wherein providing the input variables to the input layer includes:
encoding the input variables into an input vector, wherein a dimension of the input vector is defined based on a quantity of configuration groups and a quantity of operation parameters.

14. The non-transitory computer-readable medium of claim 13, wherein the set of values is further tuned by:
receiving, as output from the model, a set of performance metrics associated with execution of the application by devices having the device configuration, and
providing the set of performance metrics to the cost function.

15. The non-transitory computer-readable medium of claim 14, wherein the set of values is further tuned by:
minimizing an output of the cost function by adjusting values assigned to the operation parameters using back propagation and the model.

16. A system comprising:
a user device; and
an electronic processor communicably coupled to the user device, the electronic processor configured to:
receive, from the user device, a device configuration associated with the user device and an application;
determining a configuration group based on the device configuration;
determining a set of values for operation parameters associated with the application based on the configuration group, wherein the set of values for the operation parameters are tuned using a cost function and a model; and
provide, to the user device, the set of values for the operation parameters.

17. The system of claim 16, wherein the electronic processor is configured to tune the set of values by:
assigning random values to the set of values;
encoding the set of values into an input vector, wherein a dimension of the input vector is defined based on a quantity of configuration groups and a quantity of operation parameters;
providing the input vector to an input layer of the model;
receiving, as output from the model, a set of performance metrics associated with execution of the application by devices having the device configuration;
providing the set of performance metrics to the cost function; and
minimizing an output of the cost function by adjusting values assigned to the operation parameters using back propagation and the model.

18. The system of claim 16, wherein the device configuration includes a configuration of components of the user device associated with an instance of the application, the electronic processor further configured to:
determine the configuration group based on the configuration of the components and the instance of the application.

19. The system of claim 16, wherein the application is configured to execute on the user device, and the user device is configured to:
set the operation parameters on the user device to the set of values, and
execute the application.

20. The system of claim 19, wherein executing the application on the user device using the set of values maximizes a performance of the application on the user device.
